(19) United States
(12) Patent Application Publication
(10) Pub. No.: US 2019/0392391 A1
(43) Pub. Date: Dec. 26, 2019

(54) ROLE-BASED TASK AND DECISION RECOMMENDATION GENERATION FOR REVERSE ENGINEERING

(71) Applicant: THE BOEING COMPANY, Chicago, IL (US)

(72) Inventors: Brian N. Slack, Lebanon, IL (US); James E. Harrington, Lucas, TX (US); Paul A. Kesler, Edmond, OK (US); Stephan J. Hamstra, Webster Groves, MO (US)

(73) Assignee: THE BOEING COMPANY

(21) Appl. No.: 16/014,945

(22) Filed: Jun. 21, 2018

(51) Int. Cl. G06Q 10/10; G06F 17/30; G06Q 10/06; G06Q 50/04

(52) U.S. Cl. CPC G06Q 10/101; G06F 17/30867; G06Q 30/018; G06Q 10/063118; G06Q 50/04; G06Q 10/063112

(57) ABSTRACT

A system includes a processor. The processor is configured to generate, based on historical data and a product identifier of a product associated with a reverse engineering project, a decision recommendation associated with a second user role. The processor is also configured to generate, based on a query, a role-based task associated with a first user having a first user role. The processor is further configured to provide the decision recommendation to a second device associated with a second user having the second user role, to receive first task data from a first device associated with the first user, to generate at least one reverse engineering task based on at least the product identifier, to generate a reverse engineering artifact by performing the at least one reverse engineering task, and to store the first task data and the reverse engineering artifact in a memory.

### FIELD OF THE DISCLOSURE

The present disclosure is generally related to generating role-based tasks and decision recommendations for reverse engineering.

### BACKGROUND

Electronic system parts (e.g., integrated circuits) are often designed on proprietary systems and manufactured on production lines which become obsolete in only a few years. Maintaining a system with multiple parts can become a challenge if some of the parts become obsolete. For example, when a newer version of a part is introduced, the newer version of the part may be incompatible with other parts of the system. In some situations, the part may have been phased out completely and a newer version may be unavailable. In some instances, the part may be manufactured by a competitor. Replacing the whole system because a part is obsolete or unavailable can be expensive and time-consuming.

### SUMMARY

In a particular implementation, a system includes a memory, an input interface, a communication interface, and a processor. The memory is configured to store historical data. The input interface is configured to receive a product identifier of a product associated with a reverse engineering project, and to receive a query and a first user role. A first user having the first user role is associated with the reverse engineering project. The communication interface is configured to communicate with devices. The processor is configured to generate a decision recommendation based on the product identifier and the historical data. The decision recommendation is associated with a second user role. The processor is also configured to identify a second user having the second user role and associated with the reverse engineering project. The processor is further configured to provide, via the communication interface, the decision recommendation to a second device associated with the second user. The processor is also configured to generate a role-based task based on the query. The role-based task is associated with the first user. The processor is further configured to receive, via the communication interface, first task data (e.g., first TD) from a first device associated with the first user. The processor is also configured to generate at least one reverse engineering task based on at least the product identifier. The processor is further configured to generate a reverse engineering artifact by performing the at least one reverse engineering task. The processor is also configured to store the first task data and the reverse engineering artifact in the memory.

In another particular implementation, a method includes receiving, at a computing device, a product identifier of a product associated with a reverse engineering project. The method also includes receiving, at the computing device, a query and a first user role. A first user having the first user role is associated with the reverse engineering project. The method further includes generating, at the computing device, a decision recommendation based on the product identifier and historical data, the decision recommendation associated with a second user role. The method also includes identifying, at the computing device, a second user having the second user role and associated with the reverse engineering project. The method further includes providing the decision recommendation from the computing device to a second device associated with the second user. The method also includes generating, at the computing device, a role-based task based on the query, the role-based task associated with the first user. The method further includes receiving first task data at the computing device from a first device associated with the first user. The method also includes generating, at the computing device, at least one reverse engineering task based on at least the product identifier. The method further includes generating, at the computing device, a reverse engineering artifact by performing the at least one reverse engineering task. The method also includes storing, at the computing device, the first task data and the reverse engineering artifact in a memory.

In another particular implementation, a computer-readable storage device stores instructions that, when executed by a processor, cause the processor to perform operations including receiving a product identifier of a product associated with a reverse engineering project. The operations also include receiving a query and a first user role. A first user having the first user role is associated with the reverse engineering project. The operations further include generating a decision recommendation based on the product identifier and historical data. The decision recommendation is associated with a second user role. The operations also include identifying a second user having the second user role and associated with the reverse engineering project. The operations further include providing the decision recommendation to a second device associated with the second user. The operations further include generating a role-based task based on the query. The role-based task is associated with the first user. The operations also include receiving first task data from a first device associated with the first user. The operations further include generating at least one reverse engineering task based on at least the product identifier. The operations also include generating a reverse engineering artifact by performing the at least one reverse engineering task. The operations further include storing the first task data and the reverse engineering artifact in a memory.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a block diagram that illustrates a system operable to generate role-based tasks and decision recommendations for reverse engineering;

FIG. 2 is a flow chart that illustrates an example of a method of reverse engineering;

FIG. 3 is a flow chart that illustrates an example of a method of generating role-based tasks and decision recommendations for reverse engineering; and

FIG. 4 is a block diagram that depicts a computing environment including a computing device configured to support aspects of computer-implemented methods and computer-executable program instructions (or code) according to the present disclosure.

### DETAILED DESCRIPTION

Implementations described herein are directed to generating role-based tasks and decision recommendation related to a reverse engineering project. For example, a technician has access to a first product (e.g., an integrated circuit) and determines that a second product is to be generated based on the first product. In a particular case, the first product is to be replaced in a system (e.g., an aircraft system) by the second product. To illustrate, a specification indicates that the first product in an aircraft system (e.g., a navigation system, a braking system, or a climate control system) is to be replaced after a particular time period (e.g., after six months of installation). In another case, the first product is included in a first system and the second product is to be included in a second system that corresponds to the first system. To illustrate, a first aircraft includes the first system, and the second system is to be manufactured based on the first system and added to a second aircraft. The technician initiates a reverse engineering project by providing a product identifier (ID) of the first product to a workbench system. The workbench system generates a reverse engineering artifact by performing a reverse engineering task on the first product. For example, the technician places the first product in a lab and the workbench system uses reverse engineering techniques to generate the reverse engineering artifact. The reverse engineering artifact includes at least one of a structural model of the first product, metrology data, a component layout, a bill of materials, functional analysis data, an electrical pathway layout, or an image of the first product.

The workbench assigns generates role-based tasks and decision recommendations for the reverse engineering project. For example, the workbench system assigns users having various user roles (e.g., engineer, designer, manager, etc.) to the reverse engineering project. In a particular example, the workbench system assigns the users to the reverse engineering project in response to receiving input from the technician indicating the users. To illustrate, the technician provides input indicating that a first user (e.g., Paul Smith) and a second user (e.g., Jia Adams) having a first user role (e.g., an engineer) and a second user role (e.g., manager), respectively, are to be assigned to the reverse engineering project.

The workbench system generates role-based tasks, decision recommendations, or a combination thereof, based on historical data, the reverse engineering artifact, the product ID, input from the technician, task data, or a combination thereof. For example, the workbench system sends a first role-based task (e.g., a query) to a first device of the first user (e.g., Paul Smith) and receives first task data from the first device. To illustrate, the first device displays the first role-based task (e.g., the query), receives input (e.g., an answer) from the first user, and sends the input as the first task data to the workbench system. As another example, the workbench system generates a decision recommendation indicating that a first component of the first product is unavailable and that a second component can be used in the second product instead of the first component. The workbench system generates a draft proposal for the second product including the reverse engineering artifact, the task data, the decision recommendations, or a combination thereof. The draft proposal can be used to manufacture the second product that corresponds to a re-design of the first product based on decision recommendations, the task data, or a combination thereof. When the first product is to be replaced in a system, manufacturing the second product can be more cost-effective and efficient as compared to replacing the entire system due to the first product becoming obsolete.

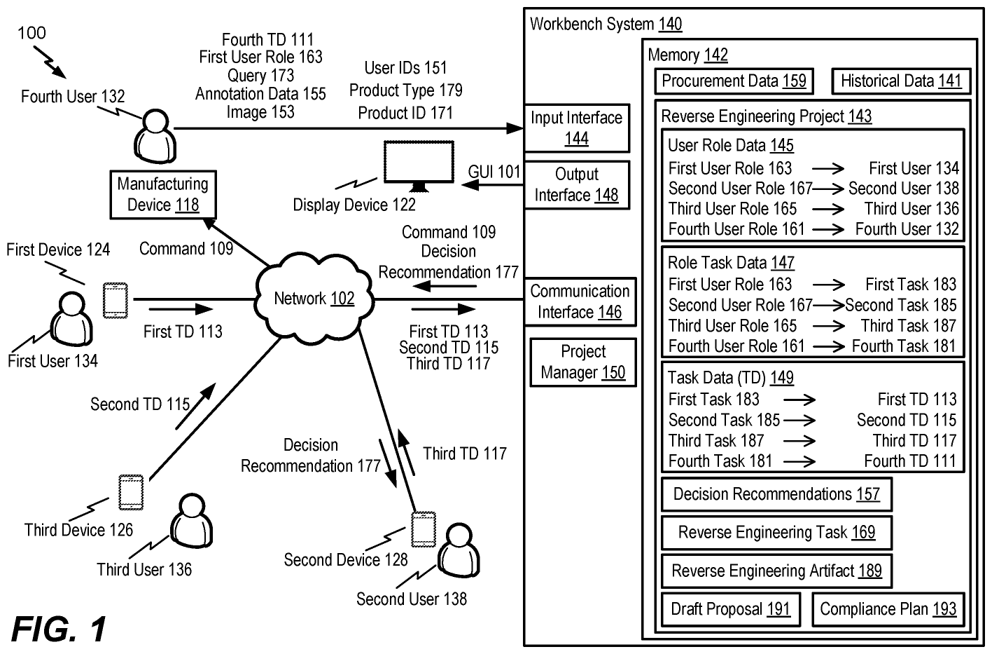

FIG. 1 is a block diagram of a system 100 that is operable to perform reverse engineering. The system 100 includes a workbench system 140 that is coupled via a network 102 to one or more devices. For example, the workbench system 140 is coupled via the network 102 to a first device 124, a second device 128, a third device 126, a manufacturing device 118, one or more additional devices, or a combination thereof. In a particular example, the first device 124, the second device 128, and the third device 126 are associated with a first user 134, a second user 138, and a third user 136, respectively. The workbench system 140 corresponds to a computer, a server, a distributed system, or a combination thereof. The network 102 includes a wired network, a wireless network, or both. One or more of the first device 124, the second device 128, the third device 126, or the manufacturing device 118 include a computer, a mobile device, a communication device, a desktop computer, a laptop, a tablet computer, a camera, an optical sensor, a laser tracker, a scanner, a metrology device, a reverse engineering tool, a robotic arm, a wafer fabrication device, an oxidation device, an epitaxial reactor device, a diffusion device, a chemical vapor deposition device, a photolithography device, an etching device, an assembly device, a wafer backgrind device, wafer saw equipment, a die attach machine, a wirebonder, a die overcoat device, molding equipment, hermetic sealing equipment, a metal can welder, branding equipment, lead finish equipment, or a combination thereof. The workbench system 140 is coupled via a communication interface 146 to the network 102.

It should be noted that in the following description, various functions performed by the system 100 of FIG. 1 are described as being performed by certain components or modules. However, this division of components and modules is for illustration only. In an alternate aspect, a function described herein as performed by a particular component or module is divided amongst multiple components or modules. Moreover, in an alternate aspect, two or more components or modules of FIG. 1 are integrated into a single component or module. Each component or module illustrated in FIG. 1 can be implemented using hardware (e.g., a field-programmable gate array (FPGA) device, an application-specific integrated circuit (ASIC), a digital signal processor (DSP), a controller, etc.), software (e.g., instructions executable by a processor), or any combination thereof.

The workbench system 140 is coupled via an output interface 148 to a display device 122. The workbench system 140 includes a memory 142. The workbench system 140 includes an input interface 144. The input interface 144 is coupled to one or more input devices, such as a touchscreen, a mouse, a keyboard, a microphone, a camera, or a combination thereof. The workbench system 140 includes a project manager 150 (e.g., a processor). The project manager 150 is configured to manage a reverse engineering project 143. It should be understood that the reverse engineering project 143 can include reverse engineering, product re-design, and more.

During operation, the project manager 150 receives, via the input interface 144, a product identifier (ID) 171 of a first product from a fourth user 132. The fourth user 132 (e.g., a technician) determines that a second product similar to the first product is requested by a client (e.g., a department) and provides user input to activate the project manager 150. The project manager 150 upon activation provides a graphical user interface (GUI) 101 to the display device 122. The GUI 101 includes an option to start a new project. In a particular aspect, the GUI 101 also includes an option to open an existing project, an option to view progress of an existing project, an option to export an existing project, an option to view a previously reverse-engineered product, one or more additional options, or a combination thereof. If the fourth user 132 selects the option to start a new project, the project manager 150 generates the reverse engineering project 143. The project manager 150 updates the GUI 101 to include a project GUI corresponding to the reverse engineering project 143 and provides the GUI 101 to the display device 122.

The project manager 150 updates the GUI 101 to request information related to the first product. In a particular aspect, the GUI 101 enables the fourth user 132 to step through a series of questions related to the first product. For example, the GUI 101 requests a type of the first product, a product ID of the first product, or both. The fourth user 132 provides a product type 179 (e.g., an electrical component) of the first product, the product ID 171 of the first product, or both. The project manager 150 assigns the product type 179, the product ID 171, or both, to the reverse engineering project 143.

In a particular implementation, procurement data 159 stored in the memory 142 indicates whether various parts are unavailable or obsolete, whether various parts have in-production models, or a combination thereof. The project manager 150 determines whether the procurement data 159 indicates that a replacement part corresponding to the first product (e.g., the product ID 171) is unavailable or obsolete. The project manager 150, in response to determining that the procurement data 159 indicates that the replacement part is available and is not obsolete, generates a procurement request indicating an order for the replacement part. Alternatively, the project manager 150, in response to determining that the procurement data 159 indicates that the replacement part is unavailable or obsolete, determines whether the procurement data 159 indicates that the first product (e.g., the product ID 171) has an in-production model. The project manager 150, in response to determining that the procurement data 159 indicates that the first product (e.g., the product ID 171) has an in-production model, generates the procurement request to indicate an order for the in-production model. The project manager 150 sends the procurement request to the fourth user 132, another user, a device, or a combination thereof. The project manager 150 generates an output indicating that the reverse engineering project 143 has ended.

The project manager 150, in response to determining that the procurement data 159 indicates that the replacement part is unavailable or obsolete and that the first product (e.g., the product ID 171) does not have an in-production model, generates at least one reverse engineering task 169 based on the product ID 171, the product type 179, or both. The project manager 150 generates at least one reverse engineering artifact 189 by performing the at least one reverse engineering task 169 using various reverse engineering techniques. For example, the project manager 150 sends a command to a three-dimensional (3D) scanner to generate a 3D point cloud by scanning the first product, generates a 3D model (e.g., a structural model) based on the 3D point cloud, and generates engineering drawings based on the 3D model. In this example, the at least one reverse engineering artifact 189 includes the 3D point cloud, the 3D model, the engineering drawings, or a combination thereof. As another example, the project manager 150 sends a command to a camera to generate images of the first product and generates a schematic diagram based on the images. The schematic diagram indicates components of the first product, connection points (e.g., solder pads) of the first product, and traces between the components. In this example, the at least one reverse engineering artifact 189 includes the images, the schematic diagram, or a combination thereof. In a particular aspect, the project manager 150 initiates performance of the at least one reverse engineering task 169 by another device and receives the at least one reverse engineering artifact 189 from the other device. The at least one reverse engineering artifact 189 includes at least one of a structural model of the first product, metrology data based on the first product, a component layout of the first product, a bill of materials, functional analysis data, an electrical pathway layout of the first product, or an image of the first product. The project manager 150 stores the at least one reverse engineering artifact 189 in the memory 142. For example, the project manager 150 adds the at least one reverse engineering artifact 189 to the reverse engineering project 143.

The project manager 150, subsequent to determining that the procurement data 159 indicates that the replacement part is unavailable or obsolete and that the first product (e.g., the product ID 171) does not have an in-production model, updates the GUI 101 to request information regarding user roles to be assigned to the reverse engineering project 143. In a particular implementation, historical data 141 stored in the memory 142 indicates one or more first user roles that are to be associated with the reverse engineering project 143. The first user roles include a user role that is to be associated with every reverse engineering project, a user role that is to be associated with reverse engineering projects of the product type 179 (e.g., electrical component), a user role that is to be associated with the product ID 171, or a combination thereof. In this implementation, the GUI 101 displays the first user roles associated with the reverse engineering project 143. The fourth user 132 (e.g., the technician) can provide input to add one or more second user roles, remove one or more use roles, or a combination thereof. The reverse engineering project 143 generates user role data 145 indicating at least one of the first user roles, at least one of the second user roles, or a combination thereof. For example, the user role data 145 includes a first user role 163 (e.g., an engineer role), a second user role 167 (e.g., a designer role), a third user role 165 (e.g., a manager role), a fourth user role 161 (e.g., a technician role), or a combination thereof. It should be understood that four user roles are provided as an illustrative example. In some other implementations, fewer than four or more than four user roles are assigned to the reverse engineering project 143.

The project manager 150 updates the GUI 101 to request information regarding users corresponding to the user roles assigned to the reverse engineering project 143. In a particular example, the fourth user 132 selects the first user 134, the second user 138, the third user 136, and the fourth user 132 for the first user role 163, the second user role 167, the third user role 165, and the fourth user role 161, respectively, assigned to the reverse engineering project 143. To illustrate, the project manager 150 receives user identifiers 151 (user IDs 151) from the fourth user 132. The user IDs 151 include a first user ID of the first user 134, a second user ID of the second user 138, a third user ID of the third user 136, a fourth user ID of the fourth user 132, or a combination thereof. The project manager 150 associates the first user 134, the second user 138, the third user 136, or the fourth user 132 with the reverse engineering project 143 in response to receiving the first user ID, the second user ID, the third user ID, or the fourth user ID, respectively. For example, the project manager 150 updates the user role data 145 based on the user IDs 151 to indicate users assigned to the user roles of the reverse engineering project 143. To illustrate, the project manager 150 updates the user role data 145 to indicate that the first user 134, the second user 138, the third user 136, and the fourth user 132 are assigned to the first user role 163, the second user role 167, the third user role 165, and the fourth user role 161, respectively, for the reverse engineering project 143.

In a particular implementation, the project manager 150 assigns one or more users to the reverse engineering project 143 independently of user input. For example, the project manager 150, in response to determining that the fourth user 132 selected the option to start the new project, that the fourth user 132 has the fourth user role 161, and that the fourth user role 161 is assigned to the reverse engineering project 143, assigns the fourth user 132 for the fourth user role 161 of the reverse engineering project 143. As another example, the project manager 150, in response to determining that the first user 134 (e.g., Paul Smith) is assigned for the first user role 163 (e.g., an engineer role) of the reverse engineering project 143, that the third user 136 (e.g., Jia Adams) has the third user role 165 (e.g., manager) for the first user 134, that the third user role 165 is assigned to the reverse engineering project 143, assigns the third user 136 (e.g., Jia Adams) for the third user role 165 of the reverse engineering project 143. To illustrate, the project manager 150 automatically assigns Jia Adams to the manager role for the reverse engineering project 143 in response to determining that Paul Smith is assigned to the engineer role for the reverse engineering project 143, that a manager is to be assigned for the reverse engineering project 143, and that Jia Adams is the manager for Paul Smith.

In a particular implementation, the project manager 150 provides permissions (e.g., access credentials) to users assigned to the reverse engineering project 143 based on the corresponding user roles. For example, the project manager 150 updates permissions to indicate that the fourth user 132 assigned to the fourth user role 161 has permission to initiate performance of the at least one reverse engineering task 169, that each of the users 132-138 assigned to at least one of the user roles 161-167 has read access to the at least on reverse engineering artifact 189, that the third user 136 assigned to the third user role 165 has read access to information received from the first user 134 assigned to the first user role 163, or a combination thereof. In this implementation, the project manager 150 enables a user to access a resource (or initiate an operation) in response to determining that the user has permission to access the resource (or initiate the operation). For example, the project manager 150 performs the at least one reverse engineering task 169 in response to receiving an input from the fourth user 132 indicating the at least one reverse engineering task 169 and determining that the fourth user 132 has permission to initiate the at least one reverse engineering task 169.

The project manager 150 generates one or more role-based tasks based on the product ID 171, the product type 179, the historical data 141, user input, task data 149 (e.g., TD), or a combination thereof. For example, the historical data 141 indicates that a fourth task 181 (e.g., a role-based task) is to be assigned to the fourth user role 161 for the reverse engineering project 143 corresponding to the product ID 171, the product type 179, or both. The project manager 150 assigns the fourth task 181 to the fourth user 132 in response to determining that the fourth user 132 is assigned to the fourth user role 161 for the reverse engineering project 143 and that the historical data 141 indicates that the fourth task 181 is to be assigned to the fourth user role 161 for the reverse engineering project 143. In a particular aspect, the project manager 150 assigns multiple role-based tasks to the same user. In a particular example, the project manager 150 assigns the fourth task 181 to the fourth user 132 in response to receiving user input indicating that the fourth task 181 is to be assigned to the fourth user 132.

The project manager 150 updates the role task data 147 to indicate the one or more role-based tasks. For example, the project manager 150 updates the role task data 147 to indicate that the fourth task 181 is assigned to the fourth user role 161. The project manager 150 updates the GUI 101 to indicate the one or more role-based tasks, sends notifications to devices of users having the corresponding user roles, or a combination thereof. For example, the project manager 150 updates the GUI 101 to indicate that the fourth task 181 is assigned to the fourth user 132, sends a notification indicating the fourth task 181 to a device of the fourth user 132, or both. In a particular aspect, the fourth task 181, the notification, or both, indicate the at least one reverse engineering artifact 189, the product type 179, the product ID 171, or a combination thereof.

The project manager 150 receives TD corresponding to the role-based tasks. For example, the project manager 150 receives fourth task data 111 (e.g., fourth TD) corresponding to the fourth task 181. As an example the fourth task 181 indicates that an image of the first product is to be generated. In a particular aspect, the fourth user 132 captures an image 153 of the first product and uploads the image 153 to the workbench system 140. In an alternate aspect, the project manager 150 sends a command to an image sensor to generate the image 153 of the first product and receives the image 153 from the image sensor. In a particular implementation, the fourth task 181 indicates that the fourth user 132 assigned to the fourth user role 161 is to initiate capture of the image 153, review the image 153, provide feedback regarding the image 153, or a combination thereof. In this implementation, the fourth TD 111 includes the image 153, a first user input indicating that the project manager 150 is to capture the image 153, a second user input indicating approval of the image 153, a third user input indicating that the project manager 150 is to capture another image of the first product subsequent to particular updates to the settings of the image sensor, or a combination thereof. In a particular aspect, the project manager 150 generates (or updates) the image 153 in response to receiving the fourth TD 111 indicating the first user input (or the third user input).

In a particular aspect, the project manager 150 receives or generates annotation data 155 associated with the image 153. The project manager 150 can generate at least a portion of the annotation data 155 independently of the fourth user 132. For example, the project manager 150 generates the portion of the annotation data 155 by performing an analysis of the image 153. As an example, the project manager 150 uses optical character recognition (OCR) to detect a part number (e.g., the product ID 171) of the first product, a part number of a component of the first product, or both. The annotation data 155 includes the part number of the first product, the part number of the component, or both. As another example, the project manager 150 uses image recognition techniques to identify the first product (or a component of the first product) in response to determining that a portion of the image 153 matches an image of a product (or an image of a component). The annotation data 155 includes an identifier of the first product (or an identifier of the component).

In a particular aspect, the project manager 150 receives at least a portion of the annotation data 155 from the fourth user 132. For example, the project manager 150 updates the GUI 101 to include the image 153 and provides the GUI 101 to the display device 122. The display device 122 outputs (e.g., displays) the GUI 101 including the image 153. The fourth user 132 uses an input device (e.g., a touch screen) to provide the portion of the annotation data 155 to the workbench system 140. The fourth TD 111 includes the image 153, the annotation data 155, or both. In a particular implementation, the project manager 150 receives the image 153, at least a portion of the annotation data 155, or both, via the input interface 144. In an alternate implementation, the project manager 150 receives the image 153, at least a portion of the annotation data 155, or both via the communication interface 146 from a first device (e.g., a mobile device, a camera, the manufacturing device 118, or another device) associated with the fourth user 132.

The project manager 150 associates the fourth TD 111 (e.g., the image 153, the annotation data 155, or both) with the reverse engineering project 143. For example, the project manager 150 generates (or updates) the TD 149 to indicate the TD corresponding to the role-based tasks. To illustrate, the project manager 150 updates the TD 149 to indicate that the fourth TD 111 corresponds to the fourth task 181, stores the fourth TD 111 in the memory 142, or both.

In a particular aspect, a user provides user data as user input to the workbench system 140 independently of role-based tasks. For example, the fourth user 132 provides the image 153, the annotation data 155, or both, to the workbench system 140 independently of the fourth task 181. The project manager 150 stores the user data (e.g., the image 153, the annotation data 155, or both) in the memory 142 and associates the user data with the reverse engineering project 143. For example, the project manager 150 adds the user data (e.g., the image 153, the annotation data 155, or both) to the reverse engineering project 143 in the memory 142.

In a particular example, the fourth user 132 provides a query 173 (e.g., a question), via the input interface 144, to the workbench system 140. The query 173 is associated with the first user role 163 (e.g., an engineer role). To illustrate, the query 173 is to be provided to the first user 134 assigned to the first user role 163 for the reverse engineering project 143. In a particular aspect, the fourth TD 111 includes the query 173 and the first user role 163. For example, the fourth user 132 has a question for the first user 134 as part of performing the fourth task 181. In an alternative aspect, the fourth user 132 provides the query 173 and the first user role 163 as user data to the workbench system 140 independently of the fourth task 181. The workbench system 140 receives the query 173 and the first user role 163 subsequent to the project manager 150 determining that the procurement data 159 indicates that the replacement part is unavailable or obsolete and that the first product (e.g., the product ID 171) does not have an in-production model.

The project manager 150 generates the first task 183 based on the query 173 and associates the first task 183 with the first user role 163. The project manager 150 updates the role task data 147 to indicate that the first task 183 is assigned to the first user role 163. The project manager 150, in response to determining that the user role data 145 indicates that the first user 134 is assigned to the first user role 163 for the reverse engineering project 143 and that the first task 183 is associated with the first user role 163, updates the GUI 101 to indicate that the first task 183 is assigned to the first user 134, sends a notification indicating the first task 183 to the first device 124, or both. In a particular aspect, a role-based task (e.g., the first task 183, a second task 185, a third task 187, or the fourth task 181) indicates the query 173, the at least one reverse engineering artifact 189, the product type 179, the product ID 171, the TD 149, the image 153, the annotation data 155, the user data, one or more decision recommendations 157, or a combination thereof.

The first device 124 displays the notification indicating the first task 183, the at least one reverse engineering artifact 189, the product type 179, the product ID 171, or a combination thereof. For example, the first device 124 displays the query 173 (e.g., request for information). The first user 134 provides an answer to the query 173. The first device 124 provides first task data 113 (e.g., first TD) corresponding to the first task 183 to the workbench system 140. In a particular example, the first task data 113 (e.g., first TD) indicates the answer to the query 173. In an alternate aspect, the project manager 150 generates the answer to the query 173 independently of the first user 134. For example, the project manager 150 generates the answer by querying a database based on the query 173. In this aspect, the first task 183 includes reviewing the query 173, editing the query 173, initiating generation of the answer, editing the answer, providing comments on the answer, or a combination thereof. The first TD 113 indicates an update to the query 173, a user input indicating that the project manager 150 is to generate the answer, an update to the answer, comments on the answer, the answer, or a combination thereof. In a particular example, the project manager 150 updates the query 173 based on the update to the query 173, generates the answer based on the user input, updates the answer based on the update to the answer, or a combination thereof. The project manager 150 updates the TD 149 to indicate that the first TD 113 is associated with the first task 183. In a particular aspect, the project manager 150 updates the GUI 101 to indicate the first TD 113 (e.g., the answer to the query 173, the comments on the answer, or both) corresponding to the first task 183. The project manager 150 thus enables the fourth user 132 to request and receive information from the first user 134, the workbench system 140, or both.

In a particular implementation, the project manager 150 generates one or more additional role-based tasks in response to receiving TD corresponding to a particular task. For example, the project manager 150, in response to receiving the first TD 113 from the first user 134 and determining that the third user role 165 (e.g., a manager role) is assigned to the reverse engineering project 143, generates a second task 185 (e.g., a request to review the answer to the query 173) indicating the first TD 113, the query 173, or both. The project manager 150 updates the role task data 147 to indicate that the second task 185 is assigned to the third user role 165. The project manager 150, in response to determining that the user role data 145 indicates that the third user 136 is assigned to the third user role 165 for the reverse engineering project 143 and that the second task 185 is assigned to the third user role 165, updates the GUI 101 to indicate that the second task 185 is assigned to the third user 136, sends a notification indicating the second task 185 to the third device 126, or both.

The third device 126 displays the notification indicating the second task 185. For example, the third device 126 displays the first TD 113 (e.g., the answer to the query 173). In a particular example, the third user 136 provides feedback (e.g., edits, comments, approval, or rejection) of the first TD 113. The third device 126 provides second task data 115 (e.g., second TD) corresponding to the second task 185 to the workbench system 140. In a particular example, the second task data 115 (e.g., second TD) indicates manager feedback on the first TD 113. In a particular aspect, the project manager 150 generates the second TD 115 by performing an analysis of the first TD 113 and provides the second TD 115 to the third device 126. In this aspect, the second task 185 includes reviewing the second TD 115, updating the second TD 115, providing comments on the second TD 115, or a combination thereof. The second TD 115 includes the updates, comments, or both. The project manager 150 receives the second TD 115 (e.g., the updates, the comments, or both) from the third device 126.

The project manager 150 updates the TD 149 to indicate that the second TD 115 is associated with the second task 185. In a particular aspect, the project manager 150 updates the GUI 101 to indicate the second TD 115 (e.g., manager feedback on the first TD 113) corresponding to the second task 185. The project manager 150 thus enables the third user 136 to provide feedback (e.g., manager feedback) on the first TD 113 (e.g., the answer to the query) received from the first user 134.

In a particular aspect, the project manager 150 generates the decision recommendations 157 based on the product ID 171, the product type 179, the historical data 141, the TD 149, the image 153, the annotation data 155, the at least one reverse engineering artifact 189, or a combination thereof. For example, the project manager 150 generates a decision recommendation 177 indicating that a second component can be used in the second product instead of a first component used in the first product. To illustrate, the project manager 150 generates the decision recommendation 177 in response to determining that the at least one reverse engineering artifact 189 indicates that the first component is detected in the first product, that the historical data 141 indicates that the first component is unavailable, and that the historical data 141 indicates that the second component performs a similar function as the first component, receives the same inputs as the first component, generates outputs having the same output format as the first component, can replace the first component, or a combination thereof. In a particular example, the project manager 150 generates the decision recommendation 177 in response to determining that the at least one reverse engineering artifact 189 indicates that the first component is detected in the first product, and that the TD 149 indicates that the second component is to be used instead of the first component in the second product.

The project manager 150 adds the decision recommendation 177 to the decision recommendations 157. In a particular implementation, the project manager 150 updates the GUI 101 to indicate the decision recommendation 177. In a particular implementation, the project manager 150 provides the decision recommendation 177 to the second device 128 of the second user 138 in response to determining that the second user 138 is assigned to the second user role 167 (e.g., a designer role) for the reverse engineering project 143.

In a particular aspect, the project manager 150 generates a third task 187 indicating the decision recommendation 177 and updates the role task data 147 to indicate that the third task 187 is assigned to the second user role 167. The project manager 150, in response to determining that the second user 138 is assigned to the second user role 167 for the reverse engineering project 143, updates the GUI 101 to indicate that the third task 187 is assigned to the second user 138. The project manager 150 sends a notification indicating the third task 187 to the second device 128. In a particular aspect, the project manager 150 receives the third task data 117 (e.g., third TD) from the second device 128. For example, the third TD 117 indicates feedback from the second user 138 regarding the decision recommendation 177. The project manager 150 updates the TD 149 to indicate that the third TD 117 is associated with the third task 187.

In a particular implementation, the project manager 150 generates a draft proposal 191. For example, the draft proposal 191 includes the at least one reverse engineering artifact 189, the TD 149, the image 153, the annotation data 155, the product type 179, the product ID 171, the decision recommendations 157, or a combination thereof. To illustrate, the project manager 150 generates a draft schematic diagram by copying a schematic diagram of the at least one reverse engineering artifact 189. In a particular example, the project manager 150 updates the draft schematic diagram based on the decision recommendation 177. To illustrate, the project manager 150, in response to determining that the decision recommendation 177 indicates that a first component is to be replaced by a second component, updates the draft schematic diagram to indicate the second component instead of indicating the first component.

In a particular example, the project manager 150 updates the draft schematic diagram based on the annotation data 155. To illustrate, the project manager 150, in response to determining that the annotation data 155 includes an identifier of the first product (or a component of the first product), updates the draft schematic diagram based on the identifier. In a particular implementation, the project manager 150, in response to determining that the annotation data 155 identifies a component as a particular type of component, updates the draft schematic diagram to indicate a corresponding component as the particular type of component. In a particular aspect, the project manager 150 updates the draft schematic diagram based on the TD 149. For example, the project manager 150, in response to determining that the TD 149 indicates that a component is to be moved from a first location to a second location, updates the draft schematic diagram to indicate the component at the second location instead of the first location.

The project manager 150 generates, based on the draft schematic diagram, a component layout, a bill of materials, an electrical pathway layout, or a combination thereof. The draft proposal 191 includes the component layout, the bill of materials, the electrical pathway layout, the draft schematic diagram, or a combination thereof. The project manager 150 updates the GUI 101 to indicate the draft proposal 191. In a particular aspect, the project manager 150 provides the draft proposal 191 to the first user 134, the second user 138, the third user 136, the fourth user 132, or a combination thereof.

The project manager 150 generates a compliance plan 193 corresponding to the draft proposal 191. For example, the project manager 150 generates change category tasks (e.g., role-based tasks) to determine a category of change (e.g., a first category minor change, a second category minor change, a third category minor change, or a major change) indicated by the draft proposal 191. In a particular aspect, the historical data 141 indicates the change category tasks to be generated for the product type 179, the product ID 171, or both. For example, the historical data 141 indicates that a first change category task including a first query (e.g., “does the change indicated by the draft proposal 191 have prior approval?”) is to be generated for the fourth user role 161. The project manager 150 generates the first change category task (e.g., the fourth task 181) for the fourth user 132 assigned to the fourth user role 161 for the reverse engineering project 143.

In a particular implementation, the project manager 150 generates an additional change category task based on TD corresponding to a previous change category task. For example, the historical data 141 indicates that a second change category task is to be generated if TD corresponding to the first change category task indicates a first value; otherwise a third change category task is to be generated. The project manager 150 generates the second change category task (e.g., the fourth task 181) in response to determining that the fourth TD 111 indicates a first value (e.g., “No”). In a particular example, the second change category task (e.g., the fourth task 181) includes a second query (e.g., “is firmware or software affected or has supplier changed?”). The project manager 150 determines the category of change (e.g., a second category minor change) based on the information (e.g., the TD 149) received (or generated) responsive to the change category tasks. For example, the project manager 150, in response to determining that task data (e.g., the fourth TD 111) corresponding to the second change category task (e.g., the fourth task 181) indicates a particular value (e.g., “No”), determines that the category of change corresponds to a second category minor change.

The project manager 150 generates compliance tasks (e.g., role-based tasks) to determine compliance of the second product indicated by the draft proposal 191. In a particular aspect, the historical data 141 indicates the compliance tasks to be generated for the category of change indicated by the draft proposal 191. For example, the historical data 141 indicates that a first compliance task (e.g., “search database for previous certification plan and reference previous certification plan to show compliance”) is to be generated for the fourth user role 161. The project manager 150 generates the first compliance task (e.g., the fourth task 181) for the fourth user 132 assigned to the fourth user role 161 for the reverse engineering project 143. The project manager 150 adds the first compliance task (e.g., the fourth task 181) to the compliance plan 193. The project manager 150 updates the GUI 101 to indicate the compliance plan 193 corresponding to the draft proposal 191.

As a particular example, the project manager 150 searches the historical data 141 for a previous certification plan. In this example, the first compliance task (e.g., the fourth task 181) includes reviewing the draft proposal 191 and the previous certification plan. The fourth user 132 provides compliance task data (e.g., the fourth TD 111) indicating whether the draft proposal 191 shows compliance based on the previous certification plan. In an alternate aspect, the project manager 150 determines whether the draft proposal 191 shows compliance based on a comparison of the draft proposal 191 and the previous certification plan. In this aspect, the first compliance task (e.g., the fourth task 181) includes reviewing the determination of the project manager 150 regarding whether the draft proposal 191 shows compliance, providing comments regarding the determination, updating the determination, or a combination thereof. The compliance task data (e.g., the fourth TD 111) indicates the determination, the update to the determination, the comments, or a combination thereof.

In a particular implementation, the project manager 150 initiates manufacturing of the second product based on the draft proposal 191. For example, the project manager 150 generates a command 109 based on the draft proposal 191 and sends the command 109 to the manufacturing device 118 to perform one or more manufacturing operations.

The system 100 thus enables the second product to be manufactured as a re-design of the first product. The project manager 150 generates role-based tasks that enable multiple users to participate in the re-design process. The project manager 150 also generates decision recommendations to enable users to make better informed decisions. The second product can be used to replace the first product in an aircraft system.

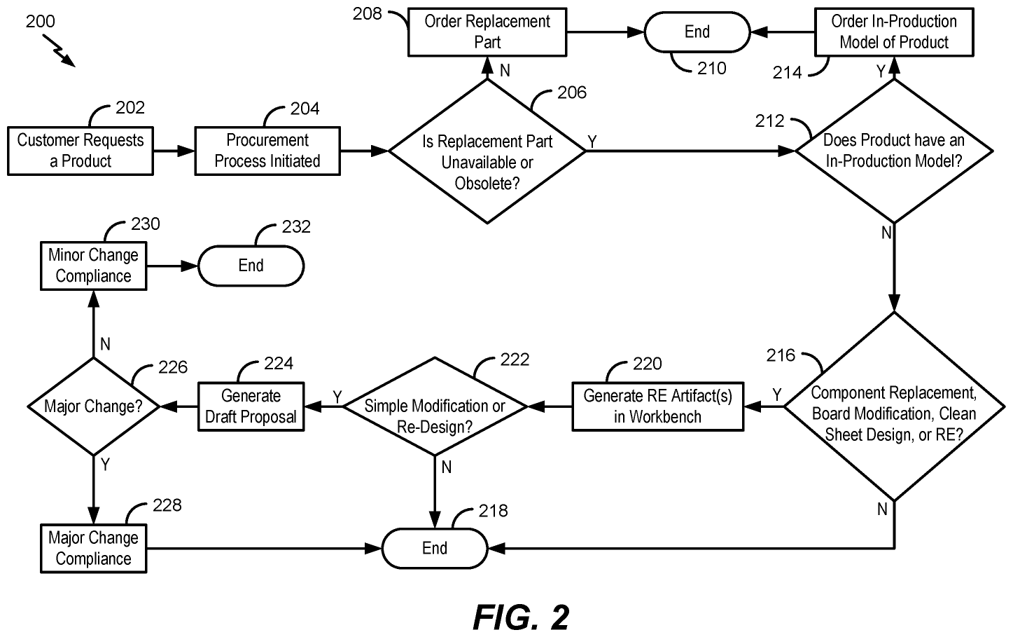

FIG. 2 is a flowchart of a method 200 of performing reverse engineering. The method 200 can be performed by one or more of the project manager 150, the workbench system 140, or the system 100 of FIG. 1.

The method 200 includes receiving a customer request for a product, at 202. For example, the project manager 150 of FIG. 1, in response to receiving the product ID 171 of a first product, determines that a second product corresponding to the first product is requested.

The method 200 also includes initiating a procurement process, at 204. For example, the project manager 150 of FIG. 1 generates a procurement request indicating the product ID 171.

The method 200 further includes determining whether a replacement part is unavailable or obsolete, at 206. For example, the project manager 150 of FIG. 1 determines whether the procurement data 159 indicates that a replacement part corresponding to the product ID 171 is unavailable or obsolete.

The method 200 includes, in response to determining that a replacement part is available (e.g. not unavailable nor obsolete), at 206, ordering the replacement part, at 208. For example, the project manager 150 of FIG. 1 updates the procurement request to indicate an order for a replacement part corresponding to the product ID 171 and initiates purchase of the replacement part by sending the procurement request to a user, a supplier, or both. The method 200 ends at 210.

The method 200 includes, in response to determining that a replacement part is unavailable or obsolete, at 206, determining whether the first product has an in-production model, at 212. For example, the project manager 150 of FIG. 1 determines whether the procurement data 159 indicates that the product ID 171 has an in-production model.

The method 200 includes, in response to determining that the first product has an in-production model, at 212, ordering the in-production model of the first product, at 214. For example, the project manager 150 of FIG. 1, in response to determining that the procurement data 159 indicates that the product ID 171 has an in-production model, updates the procurement request to indicate an order for a in-production model corresponding to the product ID 171 and initiates purchase of the in-production model by sending the procurement request to a user, a supplier, or both. The method 200 ends at 210.

The method 200 includes, in response to determining that the first product does not have an in-production model, at 212, determining whether a component replacement, a board modification, a clean sheet design, or reverse engineering (RE) is to be performed, at 214. For example, the project manager 150 of FIG. 1 generates one or more role-based tasks, such as the first task 183, the second task 185, the third task 187, the fourth task 181, or a combination thereof. In a particular aspect, the role-based tasks request (or generate) information indicating whether a component replacement, a board modification, a clean sheet design, or reverse engineering is to be performed. The project manager 150 determines, based on the TD 149, whether a component replacement, a board modification, a clean sheet design, or RE is to be performed. The method 200, in response determining that a component replacement, a board modification, a clean sheet design, or reverse engineering are not to be performed, at 216, ends at 218.

The method 200 includes, in response determining that a component replacement, a board modification, a clean sheet design, or reverse engineering is to be performed, at 216, generating reverse engineering (RE) artifacts in workbench, at 220. For example, the project manager 150 of FIG. 1, in response to determining that the TD 149 indicates that a component replacement, a board modification, a clean sheet design, or reverse engineering is to be performed, generates the at least one reverse engineering artifact 189, as described with reference to FIG. 1.

The method 200 further includes determining whether a simple modification or re-design is to be performed, at 222. For example, the project manager 150 of FIG. 1 generates one or more role-based tasks, such as the first task 183, the second task 185, the third task 187, the fourth task 181, or a combination thereof. In a particular aspect, the role-based tasks request (or generate) information indicating whether a simple modification or re-design is to be performed. To illustrate, the project manager 150 determines that the historical data 141 indicates that the first product corresponding to the product ID 171 includes a first component and that a previous reverse engineering project includes replacing the first component with a second component. The project manager 150, in response to determining that the previous reverse engineering project did not correspond to a simple modification or re-design, determines that a simple modification or re-design is not to be performed. Alternatively, the project manager 150, in response to determining that each previous reverse engineering project associated with any component of the first product corresponds to a simple modification or re-design, determines that a simple medication or re-design is to be performed. The method 200, in response to determining that a simple modification or re-design is not to be performed, at 222, ends at 210. For example, the project manager 150, in response to determining that a simple modification or re-design is not to be performed, generates an output indicating that the reverse engineering project 143 has ended.

The method 200 includes, in response to determining that a simple modification or re-design is to be performed, at 222, generating a draft proposal, at 224. For example, the project manager 150 of FIG. 1 generates the draft proposal 191, as described with reference to FIG. 1, in response to determining that a simple modification or re-design is to be performed.

The method 200 also includes determining whether the draft proposal indicates a major change, at 226. For example, the project manager 150 of FIG. 1 determines a change category indicated by the draft proposal 191, as described with reference to FIG. 1. To illustrate, the project manager 150 generates the change category tasks and determines the category of change based on the TD corresponding to the change category tasks, as described with reference to FIG. 1.

The method 200 includes, in response to determining that the draft proposal indicates a major change, at 226, generating a major change compliance plan, at 228. For example, the project manager 150 of FIG. 1 generates the compliance plan 193 based on the change category (e.g., a major change category) indicated by the draft proposal 191, as described with reference to FIG. 1. To illustrate, the compliance plan 193 includes one or more first compliance tasks corresponding to the change category (e.g., a major change category). The first compliance tasks are to be performed to determine compliance of a second product indicated by the draft proposal 191. The method 200 ends at 218.

The method 200 includes, in response to determining that the draft proposal does not indicate a major change, at 226, generating a minor change compliance plan, at 230. For example, the project manager 150 of FIG. 1 generates the compliance plan 193 based on the change category (e.g., a minor change category) indicated by the draft proposal 191, as described with reference to FIG. 1. To illustrate, the compliance plan 193 includes one or more second compliance tasks corresponding to the change category (e.g., a major change category). The second compliance tasks are to be performed to determine compliance of a second product indicated by the draft proposal 191. The method 200 ends at 232.

The method 200 thus enables the project manager 150 to generate the draft proposal 191 for the second product based on a re-design of the first product. The project manager 150 also generates the compliance plan 193 based on the extent of change indicated by the draft proposal 191.

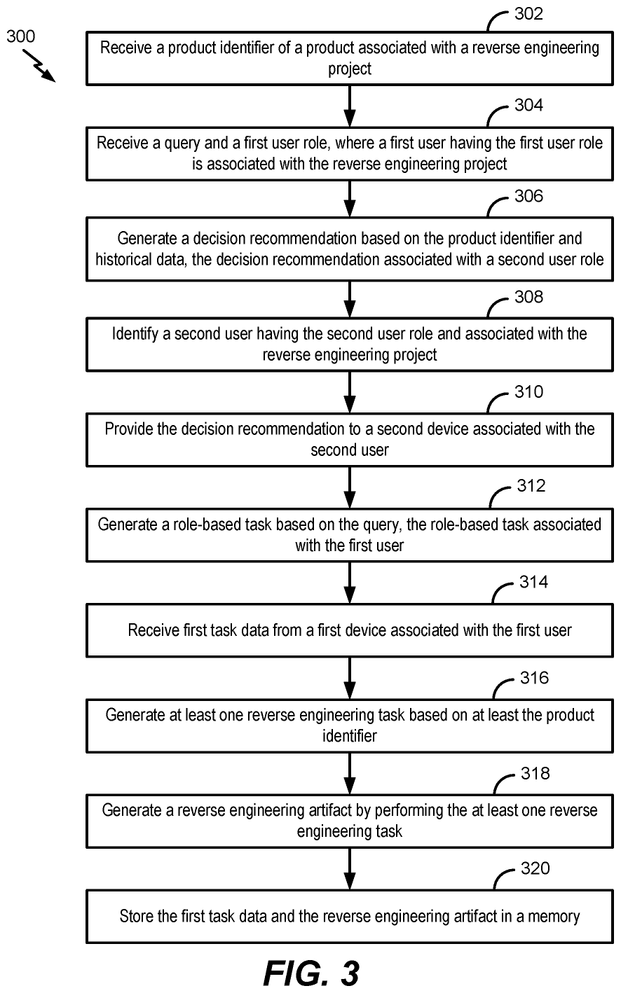

FIG. 3 is a flowchart of a method 300 of generating role-based tasks and decision recommendations for reverse engineering. The method 300 can be performed by one or more of the project manager 150, the workbench system 140, or the system 100 of FIG. 1.

The method 300 includes receiving a product identifier of a product associated with a reverse engineering project, at 302. For example, the project manager 150 of FIG. 1 receives the product ID 171 of a product associated with the reverse engineering project 143, as described with reference to FIG. 1.

The method 300 also includes receiving a query and a first user role, at 304. For example, the project manager 150 of FIG. 1 receives the query 173 and the first user role 163, as described with reference to FIG. 1. The first user 134 having the first user role 163 is associated with the reverse engineering project 143. For example, the project manager 150 assigns the first user 134 to the first user role 163 for the reverse engineering project 143.

The method 300 further includes generating a decision recommendation based on the product identifier and historical data, at 306. For example, the project manager 150 of FIG. 1 generates the decision recommendation 177 based on the product ID 171 and the historical data 141, as described with reference to FIG. 1. The decision recommendation 177 is associated with the second user role 167, as described with reference to FIG. 1.

The method 300 also includes identifying a second user having the second user role and associated with the reverse engineering project, at 308. For example, the project manager 150 of FIG. 1 identifies the second user 138 having the second user role 167 and associated with the reverse engineering project 143. To illustrate, the second user 138 is assigned to the second user role 167 for the reverse engineering project 143.

The method 300 further includes providing the decision recommendation to a second device associated with the second user, at 310. For example, the project manager 150 of FIG. 1 provides the decision recommendation 177 to the second device 128 associated with the second user 138.

The method 300 also includes generating a role-based task based on the query, at 312. For example, the project manager 150 of FIG. 1 generates the first task 183 based on the query 173, as described with reference to FIG. 1. The first task 183 is associated with the first user 134.

The method 300 further includes receiving first task data from a first device associated with the first user, at 314. For example, the project manager 150 of FIG. 1 receives the first TD 113 from the first device 124 associated with the first user 134, as described with reference to FIG. 1.

The method 300 also includes generating at least one reverse engineering task based on at least the product identifier, at 316. For example, the project manager 150 of FIG. 1 generates the at least one reverse engineering task 169 based on at least the product ID 171, as described with reference to FIG. 1.

The method 300 further includes generating a reverse engineering artifact by performing the at least one reverse engineering task, at 318. For example, the project manager 150 of FIG. 1 generates the at least one reverse engineering artifact 189 by performing the at least one reverse engineering task 169, as described with reference to FIG. 1.

The method 300 also includes storing the first task data and the reverse engineering artifact in a memory, at 320. For example, the project manager 150 of FIG. 1 stores the first TD 113 and the at least one reverse engineering artifact 189 in the memory 142, as described with reference to FIG. 1.

The method 300 thus enables generation of role-based tasks that enable multiple users to participate in a re-design process. The project manager 150 also generates decision recommendations to enable users to make better informed decisions. A second product can be manufactured based on the at least one reverse engineering artifact 189, the first TD 113, and the decision recommendation 177.

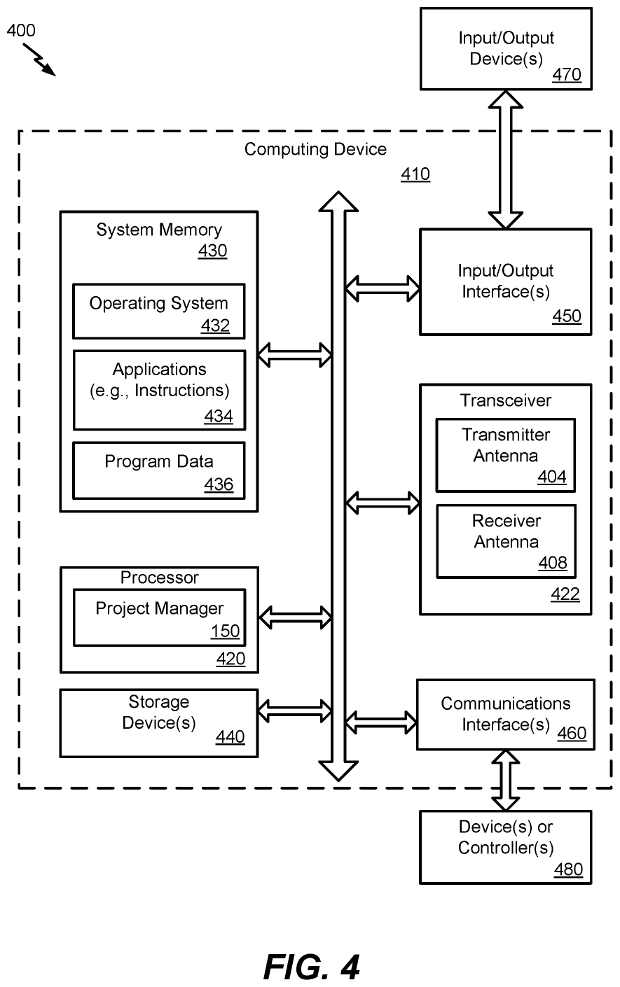

FIG. 4 is an illustration of a block diagram of a computing environment 400 including a computing device 410 configured to support aspects of computer-implemented methods and computer-executable program instructions (or code) according to the present disclosure. For example, the computing device 410, or portions thereof, is configured to execute instructions to initiate, perform, or control one or more operations described with reference to FIGS. 1-3.

The computing device 410 includes the transceiver 422. The transceiver 422 includes a transmitter antenna 404 and a receiver antenna 408. The computing device 410 includes a processor 420. In a particular aspect, the processor 420 includes the project manager 150. The processor 420 is configured to communicate with system memory 430, one or more storage devices 440, one or more input/output interfaces 450, one or more communications interfaces 460, or a combination thereof. The system memory 430 includes volatile memory devices (e.g., random access memory (RAM) devices), nonvolatile memory devices (e.g., read-only memory (ROM) devices, programmable read-only memory, and flash memory), or both. The system memory 430 stores an operating system 432, which may include a basic input/output system for booting the computing device 410 as well as a full operating system to enable the computing device 410 to interact with users, other programs, and other devices. The system memory 430 stores system (program) data 436. In a particular aspect, the memory 142 of FIG. 1 includes the system memory 430, the one or more storage devices 440, or a combination thereof.

The system memory 430 includes one or more applications 434 executable by the processor 420. As an example, the one or more applications 434 include instructions executable by the processor 420 to initiate, control, or perform one or more operations described with reference to FIGS. 1-3. To illustrate, the one or more applications 434 include instructions executable by the processor 420 to initiate, control, or perform one or more operations described with reference to the project manager 150.

The processor 420 is configured to communicate with one or more storage devices 440. For example, the one or more storage devices 440 include nonvolatile storage devices, such as magnetic disks, optical disks, or flash memory devices. In a particular example, the storage devices 440 include both removable and non-removable memory devices. The storage devices 440 are configured to store an operating system, images of operating systems, applications, and program data. In a particular aspect, the system memory 430, the storage devices 440, or both, include tangible computer-readable media. In a particular aspect, one or more of the storage devices 440 are external to the computing device 410.

The processor 420 is configured to communicate with one or more input/output interfaces 450 that enable the computing device 410 to communicate with one or more input/output devices 470 to facilitate user interaction. In a particular aspect, the input/output interfaces 450 include the input interface 144, the output interface 148 of FIG. 1, or both. The processor 420 is configured to detect interaction events based on user input received via the input/output interfaces 450. Additionally, the processor 420 is configured to send a display to the display device 122 of FIG. 1 via the input/output interfaces 450. The processor 420 is configured to communicate with devices or controllers 480 via the one or more communications interfaces 460. For example, the one or more communication interfaces 460 include the communication interface 146 of FIG. 1. In an illustrative example, a non-transitory computer-readable storage medium (e.g., the system memory 430) includes instructions that, when executed by a processor (e.g., the processor 420), cause the processor to initiate, perform, or control operations. The operations include one or more operations described with reference to FIGS. 1-3.

Examples described above are illustrative and do not limit the disclosure. It is to be understood that numerous modifications and variations are possible in accordance with the principles of the present disclosure.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

1. A system (100, 140, 400, 410) comprising:
a memory (142, 430) configured to store historical data (141);
an input interface (144, 450) configured to:
receive a product identifier (171) of a product associated with a reverse engineering project (143); and
receive a query (173) and a first user role (163), wherein a first user (134) having the first user role (163) is associated with the reverse engineering project (143);
a communication interface (146, 460) configured to communicate with devices (124, 126, 128); and
a processor (150, 420) configured to:
generate a decision recommendation (177) based on the product identifier (171) and the historical data (141), the decision recommendation (177) associated with a second user role (167);
identify a second user (138) having the second user role (167) and associated with the reverse engineering project (143);
provide, via the communication interface (146, 460), the decision recommendation (177) to a second device (128) associated with the second user (138);
generate a role-based task (183) based on the query (173), the role-based task (183) associated with the first user (134);
receive, via the communication interface (146, 460), first task data (113) from a first device (124) associated with the first user (134);
generate at least one reverse engineering task (169) based on at least the product identifier (171);
generate a reverse engineering artifact (189) by performing the at least one reverse engineering task (169); and
store the first task data (113) and the reverse engineering artifact (189) in the memory (142, 430).

2. The system (100, 140, 400, 410) of claim 1, wherein the reverse engineering artifact (189) includes at least one of a structural model of the product, metrology data, a component layout, a bill of materials, functional analysis data, an electrical pathway layout, or an image of the product.

3. The system (100, 140, 400, 410) of claim 1, wherein the input interface (144, 450) is configured to receive a user identifier (151) of the first user (134), and wherein the processor (150, 420) is configured to associate the first user (134) with the reverse engineering project (143) in response to receiving the user identifier (151).

4. The system (100, 140, 400, 410) of claim 1, wherein the processor (150, 420) is configured to associate the reverse engineering artifact (189) with the role-based task (183).

5. The system (100, 140, 400, 410) of claim 1, wherein the communication interface (146, 460) is further configured to receive an image (153), and wherein the processor (150, 420) is further configured to associate the image (153) with the reverse engineering project (143).

6. The system (100, 140, 400, 410) of claim 5, further comprising a display device (122) configured to output the image (153), wherein the input interface (144, 450) is configured to receive annotation data (155), and wherein the processor (150, 420) is configured to associate the annotation data (155) with the image (153).

7. The system (100, 140, 400, 410) of claim 6, wherein the processor (150, 420) is configured to associate the image (153) and the annotation data (155) with the role-based task (183).

8. The system (100, 140, 400, 410) of claim 1, wherein the processor (150, 420) is configured to:
determine that a third user (136) having a third user role (165) is associated with the reverse engineering project (143), the first user (134), or both;
generate a second role-based task (185) associated with the third user (136), the second role-based task (185) indicating the first task data (113);
receive, via the communication interface (146, 460), second task data (, 115) from a third device (126) associated with the third user (136); and
store the second task data (115) in the memory (142, 430).

9. A method comprising:
receiving, at a computing device (140, 410), a product identifier (171) of a product associated with a reverse engineering project (143);
receiving, at the computing device (140, 410), a query (173) and a first user role (163), wherein a first user (134) having the first user role (163) is associated with the reverse engineering project (143);
generating, at the computing device (140, 410), a decision recommendation (177) based on the product identifier (171) and historical data (141), the decision recommendation (177) associated with a second user role (167);
identifying, at the computing device (140, 410), a second user (138) having the second user role (167) and associated with the reverse engineering project (143);
providing the decision recommendation (177) from the computing device (140, 410) to a second device (128) associated with the second user (138);
generating, at the computing device (140, 410), a role-based task (183) based on the query (173), the role-based task (183) associated with the first user (134);
receiving first task data (113) at the computing device (140, 410) from a first device (124) associated with the first user (134);
generating, at the computing device (140, 410), at least one reverse engineering task (169) based on at least the product identifier (171);
generating, at the computing device (140, 410), a reverse engineering artifact (189) by performing the at least one reverse engineering task (169); and
storing, at the computing device (140, 410), the first task data (113) and the reverse engineering artifact (189) in a memory (142, 430).

10. The method of claim 9, wherein the reverse engineering artifact (189) includes at least one of a structural model of the product, metrology data, a component layout, a bill of materials, functional analysis data, an electrical pathway layout, or an image (153) of the product.

11. The method of claim 9, further comprising associating the first user (134) with the reverse engineering project (143) in response to receiving a user identifier (151) of the first user (134).

12. The method of claim 9, further comprising associating the reverse engineering artifact (189) with the role-based task (183).

13. The method of claim 9, further comprising:
receiving an image (153) at the computing device (140, 410); and
associating, at the computing device (140, 410), the image (153) with the reverse engineering project (143).

14. The method of claim 13, further comprising:
providing the image (153) from the computing device (140, 410) to a display device (122);
receiving annotation data (155) at the computing device (140, 410); and
associating, at the computing device (140, 410), the annotation data (155) with the image (153).

15. The method of claim 14, further comprising associating the image (153) and the annotation data (155) with the role-based task (183).

16. The method of claim 9, further comprising:
determining, at the computing device (140, 410), that a third user (136) having a third user role (165) is associated with the reverse engineering project (143), the first user (134), or both;
generating, at the computing device (140, 410), a second role-based task (185) associated with the third user (136), the second role-based task (185) indicating the first task data (113);
receiving second task data (115) at the computing device (140, 410) from a third device (126) associated with the third user (136); and
storing the second task data (115) in the memory (142, 430).

17. The method of claim 9, wherein the query (173) and the first user role (163) is received at the computing device (140, 410) subsequent to determining at the computing device (140, 410) that a replacement part corresponding to the product is unavailable or obsolete.

18. The method of claim 9, further comprising:
generating, at the computing device (140, 410), a draft proposal (191) based on the decision recommendation (177), the reverse engineering artifact (189), the first task data (113), or a combination thereof;
providing the draft proposal (191) to a display device (122);
receiving a user input indicating whether the draft proposal (191) corresponds to a major change;
generating a compliance plan (193) based on the user input; and
storing the compliance plan (193) in the memory (142, 430).

19. A computer-readable storage device (430) storing instructions (434) that, when executed by a processor (150, 420), cause the processor (150, 420) to perform operations comprising:
receiving a product identifier (171) of a product associated with a reverse engineering project (143);
receiving a query (173) and a first user role (163), wherein a first user (134) having the first user role (163) is associated with the reverse engineering project (143);
generating a decision recommendation (177) based on the product identifier (171) and historical data (141), the decision recommendation (177) associated with a second user role (167);
identifying a second user (138) having the second user role (167) and associated with the reverse engineering project (143);
providing the decision recommendation (177) to a second device (128) associated with the second user (138);
generating a role-based task (183) based on the query (173), the role-based task (183) associated with the first user (134);
receiving first task data (113) from a first device (124) associated with the first user (134);
generating at least one reverse engineering task (169) based on at least the product identifier (171);
generating a reverse engineering artifact (189) by performing the at least one reverse engineering task (169); and
storing the first task data (113) and the reverse engineering artifact (189) in a memory (142, 430).

20. The computer-readable storage device (430) of claim 19, wherein the instructions (434) further comprise:
providing an image (153) to a display device (122), the image (153) associated with the reverse engineering project (143);
receiving annotation data (155); and
associating the annotation data (155) with the image (153).
